(19) United States
(12) Patent Application Publication
(10) Pub. No.: US 2011/0187813 A1
(43) Pub. Date: Aug. 4, 2011

(54) Method of Connecting Mesh-Topology Video Sessions to a Standard Video Conference Mixer

(75) Inventor: Peter Musgrave, Dunrobin (CA)

(73) Assignee: MAGOR CORPORATION, Ottawa (CA)

(21) Appl. No.: 12/697,622

(22) Filed: Feb. 1, 2010

(51) Int. Cl. H04N 7/15; H04L 12/66

(52) U.S. Cl. 348/14.09; 370/352; 348/14.12; 348/E07.084

(57) ABSTRACT

A multimedia conferencing system, includes a multipoint control unit for distributing audio and video among a first set of n endpoints, where n≧1, arranged in a star configuration, wherein bidirectional audio and video channels are established between said multipoint control unit and respective endpoints of said first set, and a second set of m endpoints, where m≧2, connected to each other in a mesh configuration wherein bidirectional audio and video channels are established directly between the endpoints of the second set. Respective bidirectional video channels are established between the multipoint control unit and the respective endpoints of the second set. An audio hub is connected to the multipoint control unit over one or more bidirectional audio channels and connected to the second set of endpoints via respective bidirectional audio channels. The audio hub transfers audio between the second set of endpoints and the multipoint control unit over a common bidirectional audio channel. This arrangement permits endpoints connected in a mesh configuration to conference with endpoints in a star configuration without loss of functionality of the mesh configuration for the endpoints connected in the mesh configuration.

### FIELD OF THE INVENTION

This invention relates to the field of video conferencing, and more particularly to a method of connecting mesh-topology video sessions to a videoconference mixer, and to an apparatus for performing the method.

### BACKGROUND OF THE INVENTION

Video conferencing requires that multiple parties exchange video, audio and (optionally) collaboration material over a communications network (e.g. an IP network). A common solution to this problem is to have each party connect to a central mixer or Multipoint Control Unit (MCU), which then distributes a mixture or selection of audio and video to the other parties. This results in a connection topology that is commonly referred to as a ‘star’ since all connections radiate out from a central mixer (FIG. 1). In a star configuration the central MCU gathers all the audio and video streams from the endpoints and provides a suitable mix of the audio and video to each endpoint. For example, endpoint A needs to be able to hear audio (and see video) from all the other participants—so the role of the MCU is to mix all audio (except the audio from A) and provide that to endpoint A. Other solutions have each party connect directly, or point-to-point to all the other parties forming a ‘mesh’ of audio, video and collaboration connections (FIG. 2). In a mesh each participant sends an audio and video stream to each other member of the conference. The endpoint then locally mixes the audio from the other endpoints and provides a combined audio signal to the user at A. This topology allows each endpoint to control the presentation of video and audio based on local parameters, local user's needs and to display more than one video stream at a time.

Interconnecting a ‘star’ video or audio conference to a mesh video or audio conference creates several issues that render such a configuration undesirable to users or even unusable. With reference to FIG. 3, in order for the MCU 302 to receive audio from endpoints in the mesh it must have a connection from each of those endpoints (Endpoints A 304, B 306 and C 308 in FIG. 3). This causes an issue with the audio channels since e.g. Endpoint A will receive two copies of the audio from endpoint B; one directly from B through connection 314 and one through connection 310, via the MCU 302 and connection 312. These audio streams will have different delays and result in an unacceptable audio experience.

The current solution to this problem is to avoid it by not allowing the mesh connection when the mesh endpoints need to participate with endpoints that require a connection to an MCU, i.e. all endpoints must connect point-to-point to the MCU only. The connection to the MCU requires that the experience be reduced to that of a single video stream and only that video can be displayed. Since in general the MCU provides each endpoint with one video and audio stream, in this solution the MCU connected endpoints cannot receive multiple video streams and cannot provide users the rich experience possible with mesh connection. The method of mixing video is predetermined by the MCU capabilities and at best, in a given session, is under the control of a conference moderator.

A simple solution allowing mesh connections might be to mute the audio coming from the other mesh endpoints, but this would result in an audio stream coming via the MCU and the video arriving directly via mesh connection. It would then be difficult to align these streams to ensure that the video and audio streams are synchronized—since the video comes directly from mesh endpoints and the audio comes via the MCU. In addition the videos from the mesh participants allow simultaneous viewing of all mesh participants so it is preferred to maintain audio/video synchronization of these streams.

### SUMMARY OF THE INVENTION

The invention allows mesh and star endpoints to be interconnected while retaining all the benefits of mesh connection by providing an ‘audio hub’ (AH) element. The principle function of the AH is to combine audio from all mesh endpoints for the MCU to distribute to all star endpoints, and to distribute to all mesh endpoints the audio the MCU has mixed from all star endpoints. In the preferred embodiment of the invention the audio hub function is implemented, in a given session, by the hardware (computer) and software of the first mesh endpoint to connect to an MCU. This is quite practical using current technology and eliminates resource management problems associated with MCU provisioning. However, it will be understood that the AH function could be implemented as a separate device, independent of any endpoint, or could be moved from one mesh endpoint to another as the conference topology develops ad hoc. The audio hub location may also be based on network conditions such as available bandwidth or network latency.

More specifically this audio hub is used to collect the audio from all mesh participants and relay it on to the MCU under the control of specific switching algorithms based on audio activity (e.g. determining which mesh audio stream has the loudest speaker).

Thus, according to the present invention there is provided a multimedia conferencing system, comprising a multipoint control unit for distributing audio and video among a first set of n endpoints, where n≧1, arranged in a star configuration, wherein bidirectional audio and video channels are established between said multipoint control unit and respective endpoints of said first set; a second set of m endpoints, where m≧2, connected to each other in a mesh configuration wherein bidirectional audio and video channels are established directly between the endpoints of the second set, and wherein respective bidirectional video channels are established between said multipoint control unit and the respective endpoints of said second set; and an audio hub connected to said multipoint control unit over at least one bidirectional audio channel and connected to the second set of endpoints via respective bidirectional audio channels, and wherein said audio hub is configured to transfer audio between said second set of endpoints and said multipoint control unit over a common bidirectional audio channel.

In a preferred embodiment the audio hub is connected to the multipoint control unit over a set of bidirectional audio channels corresponding to the respective endpoints of the second set, and the audio hub is configured to select one of the endpoints of the second set as the active endpoint and transmit audio from the second set of endpoints to the multipoint control unit only over the channel corresponding to the active endpoint. The audio hub is configured to distribute the only audio received from the multipoint unit on the channel corresponding to the active endpoint the second set of endpoints.

Thus, endpoints on the star network communicate with endpoints on the mesh network via the multipoint control unit, which has control of the mixing of the video and audio. The multipoint control unit outputs a unique audio stream and common video stream to each the participating endpoints on both the star and mesh networks. For the endpoints on the star network, the video and audio streams are sent over bidirectional channels between the multipoint control unit and the endpoints in a conventional manner. When the multipoint control unit sends out audio on a particular port, it mutes the audio received on that port so as not to send audio back to its source. The endpoints on the mesh network send their audio to the multipoint control unit through the audio hub, which combines it into a single stream that appears at a single port on the multipoint control unit. The multipoint control unit mixes sends out the audio to the endpoints on the mesh through that single port. Consequently, the audio received from the mesh network is muted in the audio sent out to the mesh network. The endpoints on the mesh network receive audio from endpoints on the mesh network directly over the channels established between the endpoints on the mesh network.

The invention thus pertains to a multiparty video conference call involving at least Star Endpoints connected to a Multipoint Conference Unit (MCU) and Mesh Endpoints. The mesh endpoints connect to the MCU via the audio hub using any supported method. The Audio Hub combines the Mesh Endpoint audio signals into a single audio stream sent to the MCU. The Audio Hub selects an audio stream from the MCU to broadcast to all Mesh Endpoints.

The participants on the mesh network can thus retain a rich experience in which all parties see and hear all other parties, and wherein the streams are displayed simultaneously in high definition audio and video. Typically each receiving user has the ability to tailor the video rendering and audio to individual needs. In general there can be an arbitrary number of video and audio streams but for the purposes of exposition we consider the case where there is just one of each.

According to another aspect of the invention there is provided a method of joining one or more endpoints in a star network and two or more endpoints in a mesh network in a conference, wherein each endpoint of the star network is connected to a multipoint control unit over bidirectional audio and video channels, comprising: establishing bidirectional video channels between the respective endpoints of the mesh network and the multipoint control unit; establishing at least one bidirectional audio channel between the multipoint control unit and an audio hub; establishing bidirectional audio channels between the audio hub and the respective endpoints of the mesh network; transferring audio between the endpoints on the mesh network and the multipoint control unit through the audio hub over a common bidirectional channel between the audio hub and the multipoint control unit; and transferring audio between endpoints on the mesh network over direct bidirectional channels established between the endpoints of the mesh network.

According to a still further aspect the invention provides an audio hub for use in a multimedia conferencing system comprising a multipoint control unit for distributing audio and video among a first set of n endpoints, where n≧1, arranged in a star configuration, wherein bidirectional audio and video channels are established between said multipoint control unit and respective endpoints of said first set; and a second set of m endpoints, where m≧2, connected to each other in a mesh configuration wherein bidirectional audio and video channels are established directly between the endpoints of the second set, and wherein respective bidirectional video channels are established between said multipoint control unit and the respective endpoints of said second set; said audio hub comprising: at least one bidirectional port for connection to said multipoint control unit; a plurality of bidirectional ports for connection to respective endpoints of said second set; a unit for producing a single audio stream from audio received at said plurality of bidirectional ports; and a distribution unit for distributing a single audio stream received from the multipoint control unit to the endpoints of the mesh network.

### BRIEF DESCRIPTION OF THE DRAWINGS

The invention will now be described in more detail, by way of example only, with reference to the accompanying drawings, in which:—

FIG. 1 is a block diagram of a prior art star network;

FIG. 2 is a block diagram of a prior art mesh network;

FIG. 3 is a block diagram of a prior art interconnected star network and mesh network;

FIG. 4 is a block diagram of an interconnected star and mesh network employing an audio hub in accordance with an embodiment of the invention;

FIG. 5 is a more detailed block diagram of the audio hub;

FIG. 6 is a flow chart illustrating the operation of mesh endpoints;

FIG. 7 is a diagram illustrating the call setup protocol;

FIG. 8 is an exemplary embodiment showing the MCU media connections; and

FIG. 9 shows the RTCP handling of the audio streams.

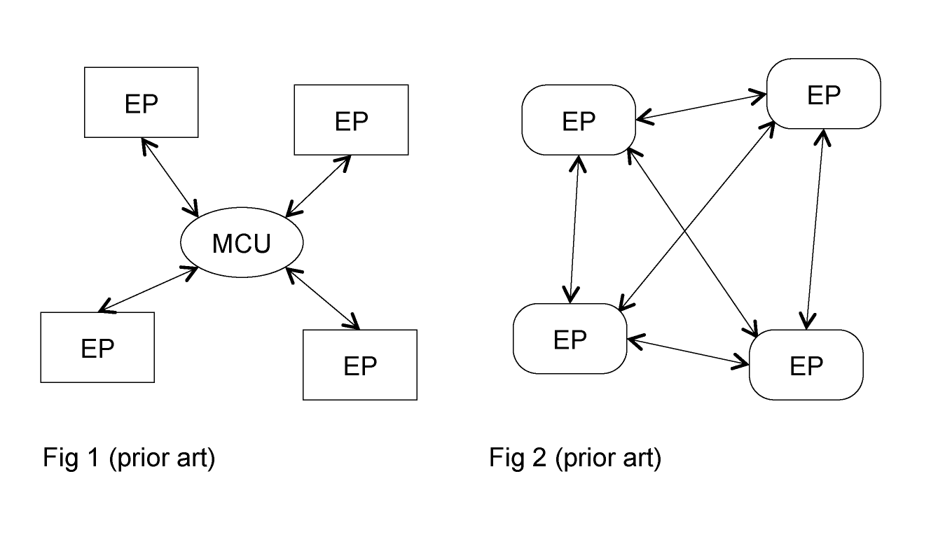

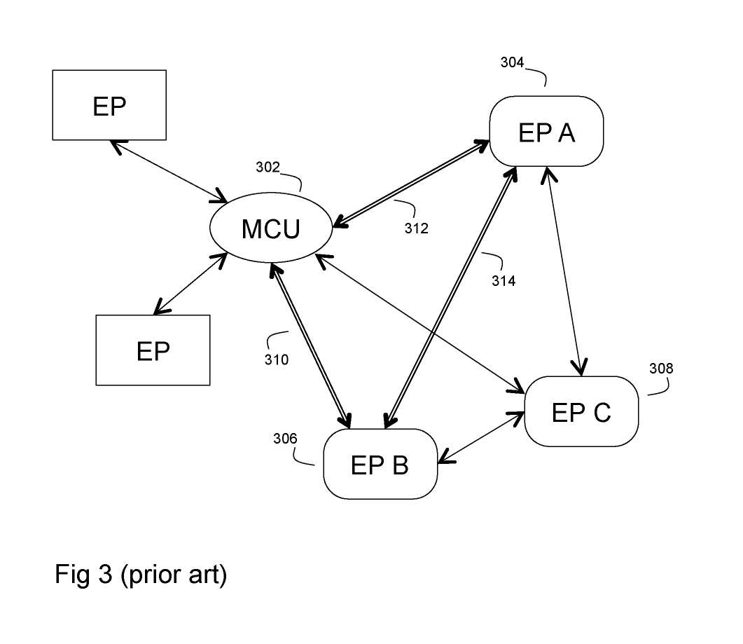

### DETAILED DESCRIPTION OF EMBODIMENTS OF THE INVENTION

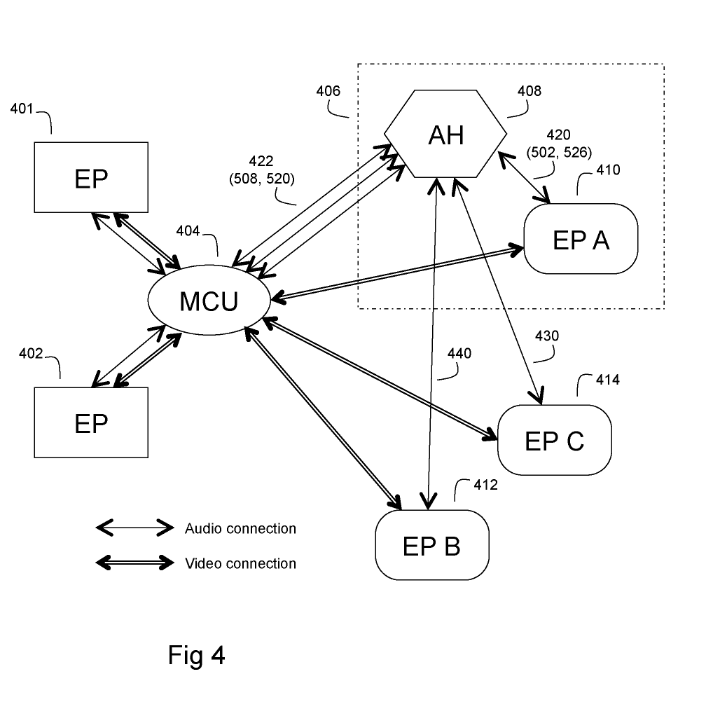

Referring to FIG. 4, the mesh connections have been omitted for clarity. The mesh connections consist of direct bidirectional audio channels and video channels between the endpoints on the mesh network, namely EP A 410, EP B 412, and EP C 414.

The audio hub (AH) 408 has one bidirectional audio connection to the MCU 404 for each mesh participant. For example, connection 422 is the connection associated with EPA 410. The role of the audio hub 408 is to produce a single audio stream from the mesh endpoints 410, 412, 414 for input to the multipoint control unit (MCU) 404. In one embodiment, the AH 408 detects the loudest speaker and uses this audio as an input to the MCU 404.

As the AH detects, in one embodiment, that participant A is the loudest speaker it provides the audio from the mesh participant, connection 420, on the MCU audio stream 422 from A. This can be any known audio conferencing method e.g. just the audio from A or alternatively, a mix of all the participants in the conference or a selection of the N loudest speakers. It then takes the audio stream from the MCU for participant A 422 (note that all connections shown in FIG. 4 are bi-directional actually comprising a send connection and a receive connection) and provides that to all the other mesh participants via connections 430 and 440 as well as EP A via 420.

Since the MCU 404 is designed to mute the received audio on the corresponding outgoing port, the MCU automatically mutes the audio from endpoints 410, 412, and 414. Thus, what the endpoints 410, 412, 414 receive from the MCU 404 is a video stream over the direct video connection between the MCU and these endpoints, and an audio stream via the AH 408 containing the mixed audio except the audio from any of the endpoints A. B, C on the mesh network, i.e. mixed audio from the star endpoints. In similar manner, the endpoints on the star network receive mixed video from the MCU 404 and mixed audio with the audio received from them muted. For example, if EP 401 is active, it will receive audio, subject to the MCU audio mixing method, from EP 402, and the common stream from AH 408, but it will not receive audio from itself.

In this scenario, when EP A 410 is the active endpoint, of course, endpoints EP B 412, and EP C 414 will not receive the audio from endpoint EPA 410 via the hub because it will be muted by the MCU 404. However, this does not matter because the endpoints EP B 412, and EP C 414 will receive the audio directly from the endpoints EP B 412 and EP C 414 via the direct connections of the mesh network, and this audio can be mixed in with the star endpoint audio mixed by the MCU and then distributed by the AH.

Moreover, the synchronization problem is solved because the audio passing directly between the endpoints of the mesh network travels along the same path and originates from the same source as the accompanying video.

In the case of the video coming from the MCU 404, which is the mixed video stream created by the MCU 404, although the video passes directly to the endpoints and the audio passes through the AH 408, the video and audio streams originate from the same source, the MCU 404, and are thus relatively easy to synchronize using known methods.

The audio and video streams between the MCU and endpoints 402, 401 can easily be synchronized because they originate from the same source and travel over the same path.

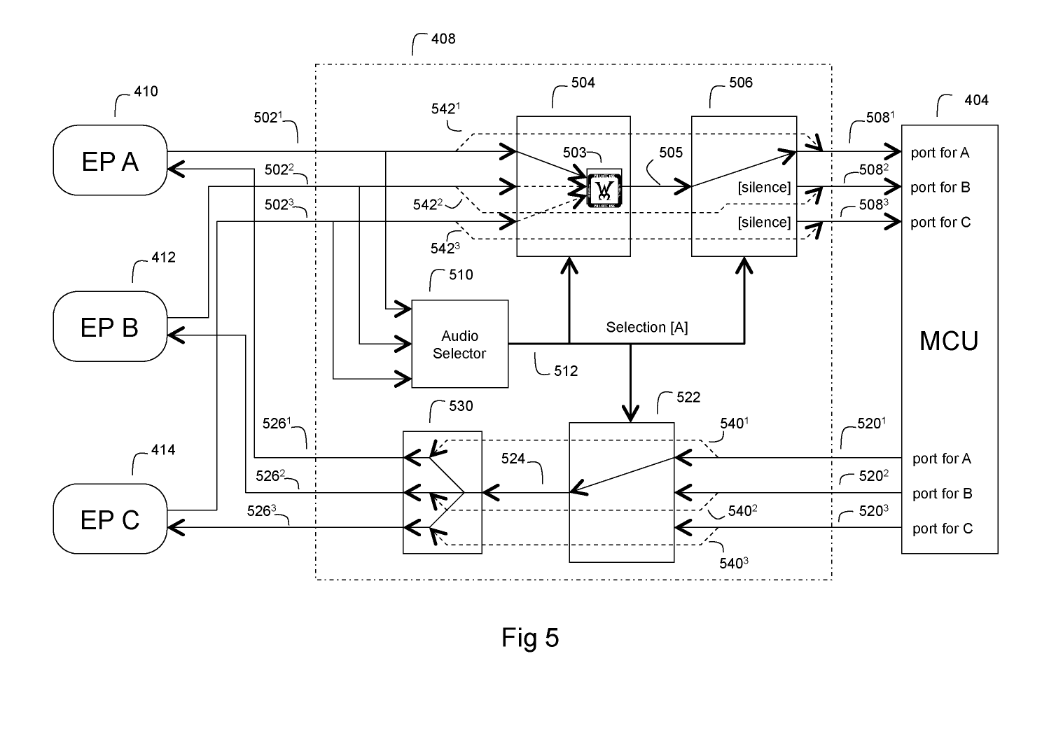

The operation of the Audio Hub 408 will now be described in more detail by referring to FIG. 5. In this example a call including three mesh endpoints 410, 412 and 414 has been set up. In general there could be any number of endpoints, the simplest case of practical importance being a three party conference comprising two mesh endpoints in conference, via the MCU, with a single star endpoint. In the figure star endpoints have been omitted for clarity.

In the exemplary embodiment, all audio signals input and output from the AH 408 are RTP (Real Time Protocol RFC3550)/UDP/IP signals. For clarity, the associated RTP transmitter or receiver functions at each connection to 408 have been omitted.

The audio signals 502, one from each endpoint 410, 412 and 414, connect to unit 504 and audio selector 510. The function of the mixer 504 is to produce a common output stream 505 from all the endpoints 410, 412, 414. This may be a mixture of audio from the different endpoints, or in one embodiment unit 504 may be simply a switch or multiplexor, controlled by the audio selector 510, selecting one audio input 502 to be output at 505.

In one case the output 505 is the sum of two or more inputs 502, the selection of which inputs 502 to sum may be controlled by selection signal 512, or otherwise, adapted in a way which would be obvious to a skilled practitioner, to select the N-loudest input signals. In the preferred embodiment N=2. More precisely the term “audio signals” in reference to FIG. 5 refers to the RTP payload, not the timestamp.

In the preferred embodiment, the Audio Selector 510 analyses the input audio signals 502, using any suitable method, to determine which endpoint is loudest at a given moment in time. As illustrated signal 502¹ is the loudest. Audio Selector 510 outputs a signal Selection 512, indicating the selected endpoint, in this example it is EP A 410. This signal controls switches 506 and 522. The de-multiplexor 506 then switches the combined audio signal 505 to the transmitter for signal 508¹ connected to the MCU 404 port for A. The de-multiplexor 506 will connect the remaining signals, 508² and 508³, for MCU ports other than A to a source of audio silence.

Reverse audio signal 520¹ from the MCU 404 port for A, destined to EP A 410 is input to multiplexor 522 which, using the same Selection signal 512, selects signal 520¹ outputting signal 524. Note that audio signals from MCU 404 ports for other endpoints, 520² and 520³, are discarded. The selected audio signal 524 is then distributed via three RTP transmitters 530 to each mesh endpoint, signals 526¹, 526² and 526³ respectively. As noted above, due to the inherent function of the MCU, the signal received on port A does not contain the audio from endpoint EP A, so the problem of duplication of signals is avoided. This means that endpoints EP B 412 and EP C 414 do not receive the audio from the endpoint A 410 via the hub either, but this does not matter because these endpoints receive the audio from endpoint EP A directly via the mesh network along with the associated video channel.

In a very simple embodiment of the invention Audio Selector 510, de-multiplexor 506 and multiplexor 522 may be omitted. In this embodiment audio signal 508¹ is always connected to combined audio signal 505 and distributed audio signal 524 is always connected to audio signal 520¹. The important point being that these signals should be connected to ports of the MCU associated with the same mesh endpoint, it does not matter which one is chosen. In this simple embodiment other MCU inputs 508² and 508³ are connected to a source of audio silence and other MCU outputs 520² and 520³, are discarded. This simple embodiment is not preferred because many MCU video mixing methods are controlled by the audio signals. Never the less, if the MCU uses only a simple continuous presence method, which is not controlled by the audio signal, this simplified embodiment will give the same result as the preferred embodiment.

In addition to the audio signal payload the RTP header carries a time stamp. Time stamp data is not processed in the same way audio data is. Rather, the time stamp for each MCU RTP stream input to the AH 408 is replicated in the corresponding output RTP stream. This is illustrated schematically by timestamp signals 542¹, 542², 542³ that are simply copied from the input RTP signals 502¹, 502², 502³ respectively into the output RTP signals 508¹, 508², 508³ respectively. Similarly timestamp signals 540¹, 540², 540³ that are simply copied from the input RTP signals 520¹, 520², 520³ respectively into the output RTP signals 526¹, 526², 526³ respectively.

As illustrated in FIG. 4, the audio streams are directed from the MCU to a different endpoint from the video streams. The video travels directly to each mesh endpoint, whereas the audio streams are all sent to the audio hub, located, in the preferred embodiment, at one of the mesh participants. This means that the standard call set up method must be adapted to establish the connections. Further more, there is a requirement to be able to relocate the AH during a session if the mesh participant which was hosting the AH disconnects from the conference.

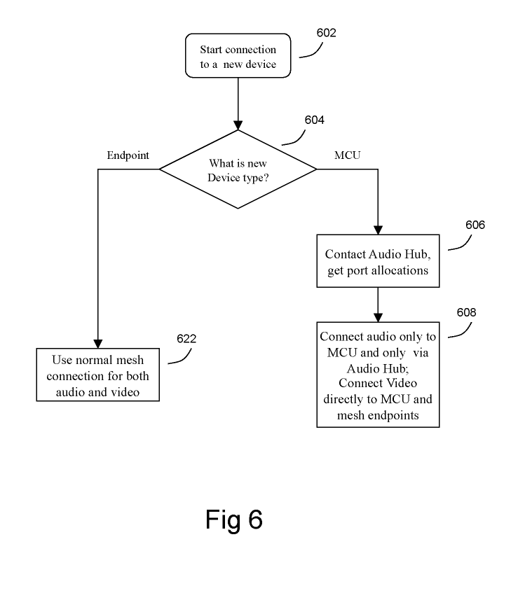

Certain features of the invention are illustrated in the flow chart FIG. 6. The endpoint starts a connection 602 with a new device. This device could be either an MCU or a Mesh Endpoint. If the new device is an MCU the process exits 604 [MCU] and contacts the Audio Hub designated for the conference step 606. Port allocations are requested for audio ports one for the MCU to connect to, one for the endpoint to connect to. The process continues to step 608 where the actual media streams are set up. Audio is connected only via the Audio Hub to the MCU. Video is connected directly to all Mesh Endpoints. Alternatively, if the new device is not an MCU the process exits 604 [endpoint] to 622. Once the node is connected it will receive a list of other participants in the mesh and it will repeat the process in FIG. 6 if it must connect to any of these other participants.

The endpoint type should be known during call establishment between an MCU and a mesh node. This can be done either by examining the signaling from the MCU (e.g. in SIP consult the User-Agent header if present), by prior knowledge based on IP address or other mechanisms (i.e. explicitly identify mesh nodes and assume the absence of this identifier implies an MCU call.) While it is simplest to know before starting a call from a mesh node that the endpoint is an MCU there are a variety of techniques in typical communications to redirect audio to the audio hub after call establishment (e.g. SIP reINVITE) and these are considered well establish practices known by practitioners in the art.

In one exemplary embodiment the Session Initiation Protocol (SIP) [RFC3261] is used as the signaling mechanism to establish the call according to change the AH location as required. The use of SIP is not a requirement—other mechanisms for call establishment could be substituted (e.g. H.323).

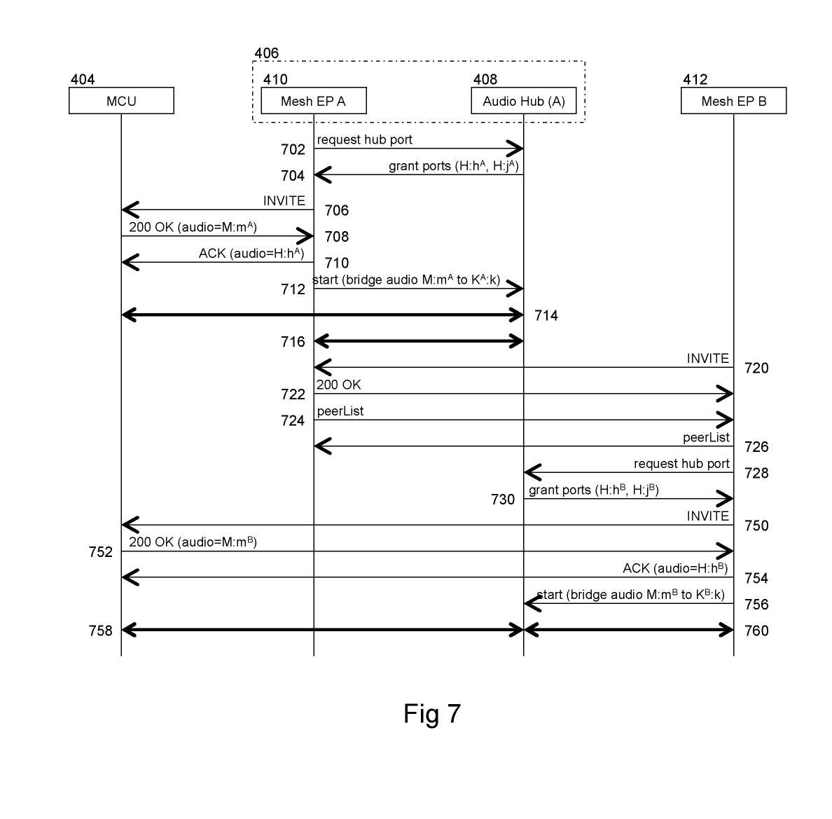

Referring to FIG. 7, a typical message sequence for a conference call setup involving an MCU and two mesh endpoints is illustrated. The sequence starts at the point after endpoint A 410, in standby, has been requested, for example by users, to connect to an MCU 404.

First, endpoint A 410 establishes the resource to be used as the Audio Hub 408. In the preferred embodiment this is instantiated in the same computer 406 as the endpoint. However, the following description applies equally to an Audio Hub elsewhere in the network.

Following this, endpoint A 410 sends a request_hub_port message 702 to AH 408. There are several mechanisms for requesting this type of additional information, here we presume the use of a SIP INFO message (see RFC2976). The AH responds with a grant_ports message 704 containing the network addresses of the ports to be used. In the example the AH grants ports H:h^{A} & H:j^{A} to be used respectively by the MCU and the requesting endpoint.

Following standard SIP protocol endpoint A 410 then connects to the MCU 404. First endpoint A 410 sends INVITE message 706 to the MCU. The MCU accepts the INVITE responding with 200 OK message 708 including the network address (M:m^{A} for example) to which 410 should send its audio media stream. However, endpoint A 410 will not send audio directly but via the AH 408. This is accomplished in the start message 712 sent from 410 to the AH 408 which contains network ports M:m^{A} received in message 708 and K^{A}:k its own network port to receive MCU audio via the AH. Audio is bridged in the AH 408 as shown in FIG. 5 and described earlier.

INVITE 706 and 200 OK 708, possibly other messages, allow the MCU and endpoint A to exchange network ports for video. These are well known methods and omitted for clarity.

Connection of additional star endpoints to the MCU, which follow known methods, is omitted for clarity. There is no particular timing relationship for star endpoint connections, which could occur before, during or after connection of mesh endpoints.

Endpoint B 412 now calls A 410 using the SIP standard method, INVITE 720, followed by message 200 OK 722 from 410. In peerList message 724, using prior art method (e.g. proprietary message encapsulated in SIP INFO message), 410 informs 412 of other endpoints to which it is connected—at this time in the example that would be just the MCU. Similarly, in peerList message 726, endpoint 412 does the same—in this example we assume none. Endpoint 412 is informed in peerList message 724 which has been adapted according to the invention that there is an MCU as part of the call and network address of the AH function to use.

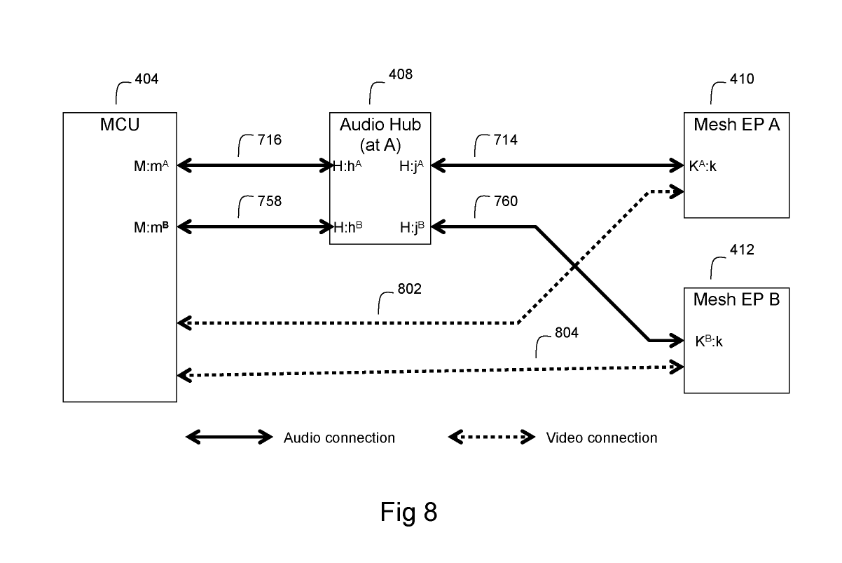

Endpoint B 412 now follows a procedure similar to end point A above to connect the MCU. Endpoint B 412 first sends a request_hub_port message 728 to AH 408 requesting it to allocate an audio port for the call it must make to the MCU. AH 408 then allocates ports that are sent to endpoint B 412 in a grant_ports message 730. The message includes information on two network ports (see later description of FIG. 8): one designated H:h^{B} is the port to which the MCU is to stream audio destined for B; the second designated H:j^{B} is the port to which B will stream audio destined for the MCU. Endpoint B now has the necessary information required to call the MCU. Call set up again follows standard SIP protocol B INVITEs the MCU, message 750, the MCU responds 200 OK in message 752. In the media negotiation it informs the MCU that video is to be sent to B (for example in of the INVITE message)—but that audio is to be sent to A. In the example the audio network port the MCU should use, H:h^{B}, is sent in ACK message 754. Once the negotiation is complete B will have learned where the audio from B to the MCU is to be sent (network port M:m^{B}) and the CODECS that the MCU can support. Accordingly start message 756 (e.g. using SIP INFO method) is sent from endpoint B 412 to the AH 408, referencing ports M:m^{B} and K^{B}:k. This starts audio streams 758 and 760 bridged as shown in FIG. 5 and described earlier.

The call is now established and B sends video to the MCU and audio to A.

For further clarity audio media streams 716, 714, 758 & 760 set up according to the example in FIG. 7 are illustrated in physical block diagram FIG. 8. Video streams, 802 between endpoint A 410 and the MCU 404, and video stream 804 between endpoint B 412 and the MCU 404, which were also set up in FIG. 7 but not described are shown here for completeness.

In summary an audio hub 408 at endpoint A relays the RTP packets from the MCU 404 to B 412 and from B to the MCU. The payload is selected based on the active speaker and the RTP timestamp is copied across to the outgoing packet to B. This is required for correct synchronization of audio and video at B.

In cases where it is necessary to relocate the AH to another endpoint in the mesh a similar process can be followed. When an endpoint hosting the AH disconnects the other endpoints in the mesh determine this and select a new AH. This can be done by e.g. a re-exchange of peerinfo messages between the nodes and having each node apply a globally unique selection algorithm to the list of remaining mesh participants. This could vary from a simple lexographic comparison of node names to a more complex algorithm based on network topology. Following well-known SIP model each endpoint then requests a new port allocation from the AH and then sends a reINVITE which updates the MCU and informs it of the new audio destination. Once the MCU has responded to the reINVITE then an AH update message tells the new AH where to send video to.

The AH must also provide information to allow existing mechanisms to ensure audio-video synchronization at the receiver to operate correctly. It is common for each of the audio and video RTP streams to have an associated channel of control information carried by RTCP (RFC3550). These packets contain sender reports, which indicate when packets of a specific timestamp were sent. By examining the information in these packets for the audio and video streams from a common source the receiver can determine if there is an arrival offset in the packet streams and adjust them accordingly by adding delay to one or the other streams. This ensures ‘lipsync’ i.e. that the video image and audio are aligned in time.

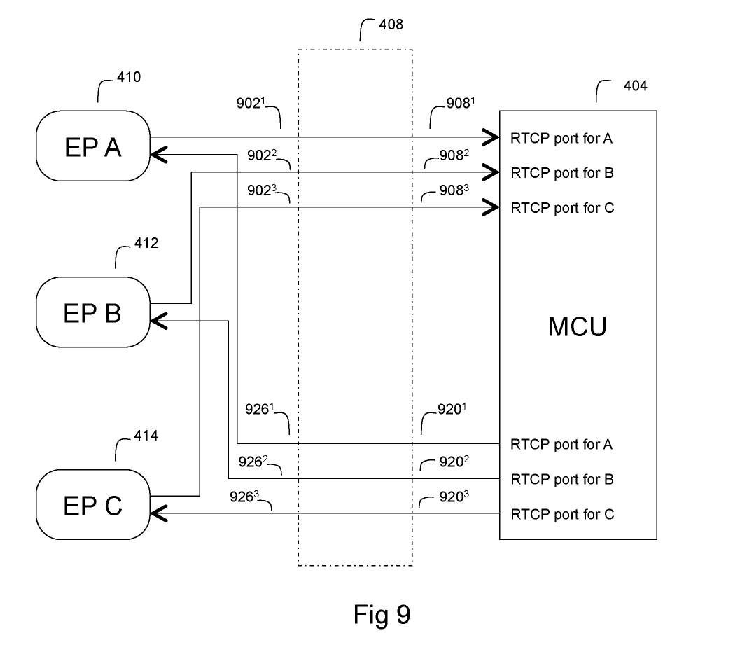

If RTCP is used the RTCP signals follow the same network path as the associated RTP stream. However no processing is done in the Audio Hub, RTCP signals are simply repeated at the corresponding output. FIG. 9 illustrates this. RTCP signals 902 from endpoints are repeated to RTCP signals 908 connected to the MCU 404 port associated with the source endpoint. Similarly RTCP signals 920 from the MCU 404 are repeated in the RTCP signals 926 for each endpoint respectively. It will be understood that although no processing is done on the RTP payload within the AH 408, the RTCP signal is received and retransmitted according to well known IP methods.

The RTCP streams follow the same paths as the primary RTP stream. The video RTCP will go directly from the MCU to the mesh endpoint. The audio RTCP will go to the AH—which may be on a different mesh endpoint. The endpoint hosting the AH then forwards the RTCP packets to A in accordance with it's action as a transcoder in the definitions of RFC3550. This ensures that each endpoint receives sender reports for audio and video that bear the existing timestamps.

Embodiments of the invention thus provide a convenient way of establishing interoperability between legacy networks dependent on a MCU and mesh networks with their richer multimedia experience in such a way that allows the endpoints on the mesh network to retain the full richness of the mesh experience with participating endpoints on the mesh network while being able to communicate at the same time with endpoints on the star network under the less rich user experience typical of the star network.

I claim:

1. A multimedia conferencing system, comprising:
a multipoint control unit for distributing audio and video among a first set of n endpoints, where n≧1, arranged in a star configuration, wherein bidirectional audio and video channels are established between said multipoint control unit and respective endpoints of said first set;
a second set of m endpoints, where m≧2, connected to each other in a mesh configuration wherein bidirectional audio and video channels are established directly between the endpoints of the second set, and wherein respective bidirectional video channels are established between said multipoint control unit and the respective endpoints of said second set; and
an audio hub connected to said multipoint control unit over at least one bidirectional audio channel and connected to the second set of endpoints via respective bidirectional audio channels, and wherein said audio hub is configured to transfer audio between said second set of endpoints and said multipoint control unit over a common bidirectional audio channel.

2. A system as claimed in claim 1, wherein said audio hub is connected to said multipoint control unit over a set of bidirectional audio channels corresponding to said respective endpoints of said second set, and wherein said audio hub is configured to select one of the endpoints of the second set as the active endpoint and transmit audio from said second set of endpoints to the multipoint control unit only over the channel corresponding to the active endpoint, and wherein said audio hub is configured to distribute the audio received from the multipoint unit on the channel corresponding to the selected endpoint the second set of endpoints.

3. A system as claimed in claim 2, wherein said audio hub is configured to select the loudest endpoint as the active endpoint.

4. A system as claimed in claim 3, wherein said audio hub further comprises a mixer to mix audio from at least one other endpoint of the second set with the audio from the endpoint selected as the active endpoint.

5. A system as claimed in claim 1, wherein each pair of audio and video channels between the multipoint control unit and the endpoints of the second set are each associated with a control channel carrying timing information so that a receiving entity can determine any timing offset between the audio and video streams, and wherein the control channel associated with the audio channel passes through the audio hub.

6. A system as claimed in claim 5, wherein control channels carry RTCP packets.

7. A system as claimed in claim 1, wherein a connection is established between the multipoint control unit and an endpoint of the second set using a session initiation protocol (SIP).

8. A system as claimed in claim 1, wherein said bidirectional channels are established as IP connections.

9. A method of joining one or more endpoints in a star network and two or more endpoints in a mesh network in a conference, wherein each endpoint of the star network is connected to a multipoint control unit over bidirectional audio and video channels, comprising:
establishing bidirectional video channels between the respective endpoints of the mesh network and the multipoint control unit;
establishing at least one bidirectional audio channel between the multipoint control unit and an audio hub;
establishing bidirectional audio channels between the audio hub and the respective endpoints of the mesh network;
transferring audio between the endpoints on the mesh network and the multipoint control unit through the audio hub over a common bidirectional channel between the audio hub and the multipoint control unit; and
transferring audio between endpoints on the mesh network over direct bidirectional channels established between the endpoints of the mesh network.

10. A method as claimed in claim 9, wherein said audio hub is connected to said multipoint control unit over a set of bidirectional audio channels corresponding to said respective endpoints of said second set, and wherein said audio hub selects one of the endpoints of the mesh network as the active endpoint and transmits audio from the endpoints of the mesh network to the multipoint control unit only over the channel corresponding to the active endpoint, and wherein said audio hub distributes the audio received from the multipoint unit on the channel corresponding to the endpoint selected as the active endpoint.

11. A method as claimed in claim 10, wherein the audio hub selects the loudest endpoint as the active endpoint.

12. A method as claimed in claim 11, wherein the audio hub mixes audio from at least one other endpoint of the mesh network with the audio from the endpoint selected as the active endpoint.

13. A method as claimed in claim 9, wherein carrying timing information is carried with each audio and video channel between the multipoint control unit and the endpoints of the mesh network, and a receiving entity determines any timing offset between a pair of audio and video stream, and wherein the timing information associated with the audio channel passes through the audio hub.

14. A method as claimed in claim 23, wherein the timing information is carried as RTCP packets.

15. A method as claimed in claim 9, wherein a connection is established between the multipoint control unit and an endpoint of the second set using a session initiation protocol (SIP).

16. A method as claimed in claim 9, wherein said bidirectional channels are established as IP connections.

17. An audio hub for use in a multimedia conferencing system comprising a multipoint control unit for distributing audio and video among a first set of n endpoints, where n≧1, arranged in a star configuration, wherein bidirectional audio and video channels are established between said multipoint control unit and respective endpoints of said first set; and a second set of m endpoints, where m≧2, connected to each other in a mesh configuration wherein bidirectional audio and video channels are established directly between the endpoints of the second set, and wherein respective bidirectional video channels are established between said multipoint control unit and the respective endpoints of said second set; said audio hub comprising:
at least one bidirectional port for connection to said multipoint control unit;
a plurality of bidirectional ports for connection to respective endpoints of said second set;
a unit for producing a single audio stream from audio received at said plurality of bidirectional ports; and
a distribution unit for distributing a single audio stream received from the multipoint control unit to the endpoints of the mesh network.

18. An audio hub as claimed in claim 17, further comprising a plurality of ports for connection to the multipoint control unit corresponding to the respective ports for connection to the endpoints of the mesh network, and said unit comprises a selector for selecting one of ports for connection to the multipoint control unit as the active port, whereby audio is sent to the multipoint control unit via the active port, and audio received via the active port is distributed to the endpoints on the mesh network.

19. An audio hub as claimed in claim 18, wherein said selector selects the port corresponding to the loudest endpoint as the active port.

20. An audio hub as claimed in claim 17, wherein said unit comprises a mixer for mixing audio from two endpoints of the mesh network into a single audio stream for transmission to the multipoint control unit.

21. An audio hub as claimed in claim 17, which is implemented as part of an endpoint on the mesh network.
